(19) United States
(12) Patent Application Publication
(10) Pub. No.: US 2025/0023895 A1
(43) Pub. Date: Jan. 16, 2025

(54) SYSTEMS AND METHODS FOR METAVERSE MONITORING

(71) Applicant: ZeroFOX, Inc., Baltimore, MD (US)

(72) Inventors: Michael Morgan Price, Baltimore, MD (US); Jason Emile Sumpter, Abingdon, MD (US)

(73) Assignee: ZeroFOX, Inc., Baltimore, MD (US)

(21) Appl. No.: 18/768,504

(22) Filed: Jul. 10, 2024

Related U.S. Application Data
(60) Provisional application No. 63/512,780, filed on Jul. 10, 2023.

(51) Int. Cl. H04L 9/40

(52) U.S. Cl. CPC H04L 63/1425

(57) ABSTRACT

The disclosed systems and methods are configured for metaverse monitoring and alerting therefrom.

### CROSS-REFERENCE TO RELATED APPLICATION

This application claims priority to U.S. Provisional Application Ser. No. 63/512,780,dated Jul. 10, 2023, which is incorporated by reference in its entirety.

### BACKGROUND OF THE DISCLOSURE

The metaverse, which generally refers to various virtual environments, on a grander scale is relatively new and still in the early adoption stage. While virtual reality has existed in some fashion for a while, the idea of an interconnected virtual environment is much newer. In these virtual spaces, users are able to (e.g., via a head mounted display or some other similar type of device) socially interact with others and engage in an open-world environment, similar to social media. However, just as the rise of social media lead to an increase in cybercrimes, the increase in usage and participation in the metaverse provides a new medium for threat actors to perform cybercrimes and pose cyberthreats.

### SUMMARY OF THE DISCLOSURE

According to one aspect of the present disclosure, a system for monitoring a virtual reality environment for cyberthreats can include a server. The server can include one or more processors and a memory storing instructions that, when executed, cause the one or more processors to perform a process operable to collect content from a virtual reality environment; transform at least part of the collected content into a textual format; execute at least one security rule on the transformed content to detect threatening content; and in response to detecting the threatening content, transmit an alert to a user device.

In some embodiments, collecting the content from the virtual reality environment can include ingesting content via a server-controlled avatar or bot operating within the virtual reality environment. In some embodiments, ingesting the content via the server-controlled avatar or bot can include recording audio within the virtual reality environment. In some embodiments, ingesting the content via the server-controlled avatar or bot can include recording video within the virtual reality environment. In some embodiments, the process can be operable to stream the collected content via the server-controlled avatar or bot. In some embodiments, the process can be operable to navigate the server-controlled avatar or bot within the virtual reality environment.

In some embodiments, transforming the at least part of the collected content into a textual format can include applying one or more speech-to-text algorithms to the collected content. In some embodiments, the process can be operable to, prior to executing the at least one security rule, perform a text-normalization procedures on the transformed content.

According to another aspect of the present disclosure, a computer-implemented method, performed by one or more processors, for monitoring a virtual reality environment for cyberthreats can include collecting content from a virtual reality environment; transforming at least part of the collected content into a textual format; executing at least one security rule on the transformed content to detect threatening content; and in response to detecting the threatening content, transmitting an alert to a user device.

In some embodiments, collecting the content from the virtual reality environment can include ingesting content via a server-controlled avatar or bot operating within the virtual reality environment. In some embodiments, ingesting the content via the server-controlled avatar or bot can include recording audio within the virtual reality environment. In some embodiments, ingesting the content via the server-controlled avatar or bot can include recording video within the virtual reality environment.

In some embodiments, the computer-implemented method can include streaming the collected content via the server-controlled avatar or bot. In some embodiments, the computer-implemented method can include navigating the server-controlled avatar or bot within the virtual reality environment. In some embodiments, transforming the at least part of the collected content into a textual format can include applying one or more speech-to-text algorithms to the collected content. In some embodiments, the method can include, prior to executing the at least one security rule, perform a text-normalization procedures on the transformed content.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

The drawings are not necessarily to scale, or inclusive of all elements of a system, emphasis instead generally being placed upon illustrating the concepts, structures, and techniques sought to be protected herein.

FIG. 1 is a block diagram of an example system for metaverse monitoring according to some embodiments of the present disclosure.

FIG. 2 is an example flowchart for metaverse monitoring that can be performed within the system of FIG. 1 according to some embodiments of the present disclosure.

FIG. 3 is an example process for generating threat alerts from a metaverse environment that can be performed within the system of FIG. 1 according to some embodiments of the present disclosure.

FIG. 4 is an example server device that can be used within the system of FIG. 1 according to an embodiment of the present disclosure.

FIG. 5 is an example computing device that can be used within the system of FIG. 1 according to an embodiment of the present disclosure.

### DESCRIPTION

The following detailed description is merely exemplary in nature and is not intended to limit the invention or the applications of its use.

Embodiments of the present disclosure relate to systems and methods for metaverse monitoring. The disclosed embodiments relate to a system that can protect organizations, brands, employees, and other individuals and/or entities by extending cybersecurity coverage into the metaverse. The term “metaverse” can represent various types of environments/platforms/systems/sites/etc. that offer virtual and/or augmented reality. In some embodiments, the term “metaverse” can also be inclusive of virtual worlds that may not employ virtual reality itself (e.g., a head-mounted virtual reality display) but still operate as a socially interconnected digital world. Examples of environments can include Horizon Worlds, VRChat, Portal VR, The Wild, Altspace VR, Cluster, Telia VR Conference, Hoppin', Part. Space, and the like. The disclosed systems and methods can monitor for events and data in the metaverse (e.g., VR chatrooms, VR rooms, etc.) that could be threating or harmful to an entity. The system can control a bot or avatar as a persona that collects data (e.g., audio and video streams) based on various intelligence requirements. The collected data can be transformed and translated into a format such that it can be processed by a rule engine that applies cybersecurity-based rules to identify threats, which can then trigger alerts to be transmitted to the relevant entity.

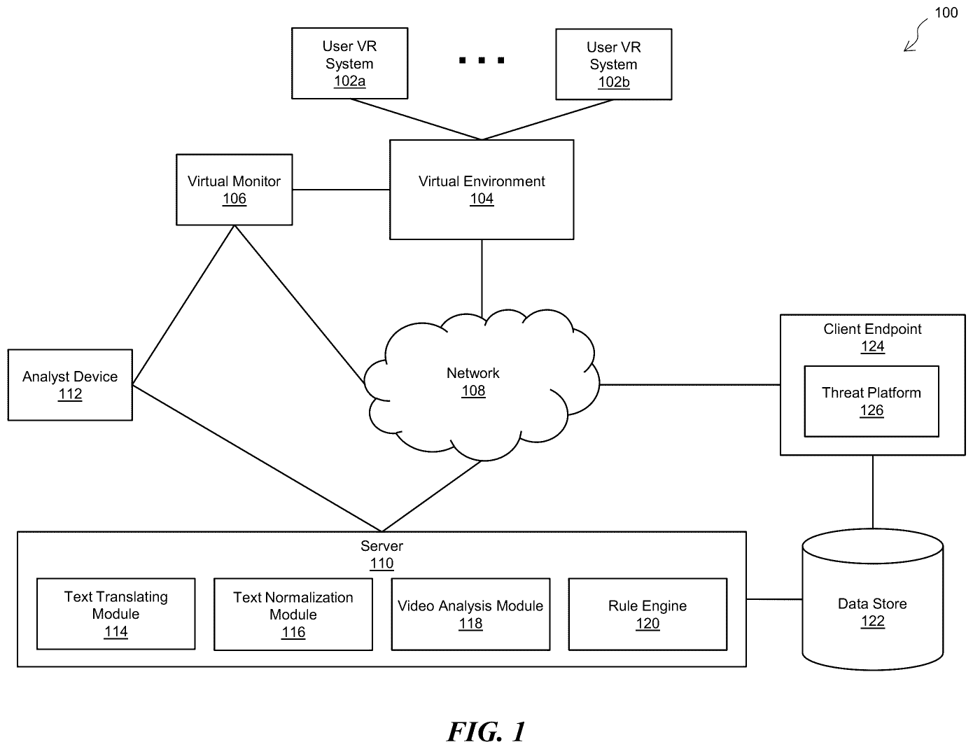

FIG. 1 is a block diagram of an example system 100 for metaverse monitoring according to some embodiments of the present disclosure. The system 100 can include a virtual environment 104 in which a plurality of user VR systems 102a-b (herein referred to singularly as a user VR system 102 or collectively as user VR systems 102). As discussed above, the virtual environment 104 can include various VR and/or augmented environments or other digital worlds that may not utilize VR. A user VR system 102 can include various devices or collections of devices that enable a user to access the virtual environment 104, such as a computer, console, smart device, and/or a headset or other head-mounted display. A virtual monitor 106 can also be connected to or operating within the virtual environment 104. In some embodiments, the virtual monitor 106 can include a bot, avatar, or other type of persona controlled in order to monitor various events within the virtual environment 104. The virtual monitor 106 can be configured to collect content from the virtual environment 104, such as recording video or audio or relaying streaming content. The virtual monitor 106 can then transmit collected content to the server 110 via network 108 for processing and analysis. In some embodiments, the virtual monitor 106 can collect content based on intelligence requirements, such as those defined or input by an analyst device 112.

The system 100 can also include a client endpoint 124. In some embodiments, the client endpoint 124 may be a device in which an organization (e.g., company, school, firm, etc.) can access a threat platform 126 (e.g., via an application or web browser) to manage the security of their organization. In some embodiments, the system 100 can include any number of client endpoints 124 as the system 100 may operate on behalf of numerous organizations that may include any number of client endpoints 124. In some embodiments, the threat platform 126 can enable a user access various search tools, such as a cyber threat intelligence platform to search threat data, threat information, and threat intelligence. This also allows a user to access results such as finished intelligence with analyst feedback, raw data, and processed threat information. In some embodiments, the threat platform 126 can include the search functionality as described in U.S. application Ser. No. 17/646,432 (“Systems and methods for unified cyber threat intelligence searching”). The search tool within the threat platform 126 can allow the user of the client endpoint 124 to access the data store 122, which stores and maintains processed content on behalf of the server 110. In some embodiments, the data store 122 can be a data lake that includes various search clusters. In some embodiments, each search cluster may be implemented as an Elasticsearch cluster that provides access to an indexed Elasticsearch database. In addition, the analyst device 112 is associated with the organization managing the server 110 and is used by an analyst or other type of security-based employee.

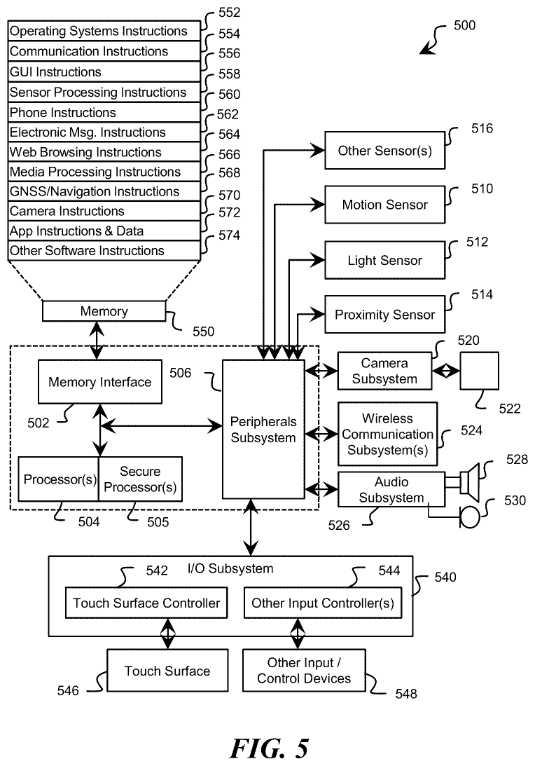

A client endpoint 124 and/or an analyst device 112 can include one or more computing devices capable of receiving user input, transmitting and/or receiving data via the network 108, and or communicating with the server 110. In some embodiments, a client endpoint 124 and/or an analyst device 112 can be a conventional computer system, such as a desktop or laptop computer. Alternatively, a client endpoint 124 and/or an analyst device 112 can be a device having computer functionality, such as a personal digital assistant (PDA), a mobile telephone, a smartphone, or other suitable device. In some embodiments, a client endpoint 124 and/or an analyst device 112 can be the same as or similar to the computing device 500 described below with respect to FIG. 5.

The network 108 can include one or more wide areas networks (WANs), metropolitan area networks (MANs), local area networks (LANs), personal area networks (PANs), or any combination of these networks. The network 108 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 108 can also use standard communication technologies and/or protocols.

As shown in FIG. 1, the server 110 can include a text translating module 114, a text normalization module 116, a video analysis module 118, and a rule engine 120. In some embodiments, the text translating module 114 is configured to receive audio and/or video streams received from the virtual monitor 106 and perform various speech to text algorithms to extract textual information from the received content. In some embodiments, the text normalization module 116 is configured to perform various text normalization procedures on the text identified in the video/audio content by the text translating module 114. Text normalization can generally include various techniques for reducing variety and randomness within textual strings, such as stemming and lemmatization, which reduce inflectional forms and derivationally related forms of a word to a common base form. Text normalization can generally improve the efficiency in which various algorithms can process textual content. In some embodiments, the video analysis module 118 is configured to analyze a video received from the virtual monitor 106, such as via a machine learning algorithm trained to identify various indicators of a threat or harmful information.

In some embodiments, the rule engine 120 is configured to perform rule-based detection of threats and violations by analyzing content, such as the textual content as discussed in relation to the text translating module 114 above. The rule engine 120 can be configured to execute rules against content and alert devices associated with entities in which the content relates to. For example, an entity may want to detect weapons, for example, guns on social media and may implement a rule that includes an object detection algorithm (or the results thereof) trained to analyze posts for guns. The rule engine 120 may receive a large amount of posts from third-party data sources, execute the script contained in the rule on each post, and, if an execution of the rule corresponds to a result indicative of a gun, then an alert may be sent to a device associated with the entity. In some embodiments, the rule engine 120 can operate in a similar fashion to the rule engine described in U.S. application Ser. No. 16/876,772 (“Configurable system for detecting social media threats”).

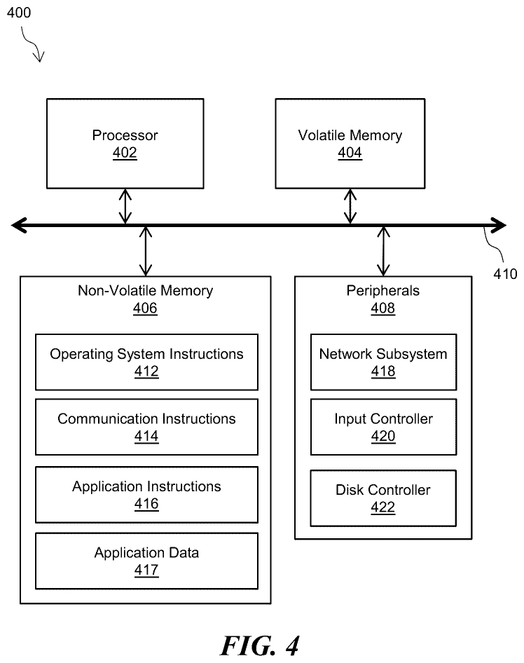

The server 110 may include any combination of one or more of web servers, mainframe computers, general-purpose computers, personal computers, or other types of computing devices. The server 110 may represent distributed servers that are remotely located and communicate over a communications network, or over a dedicated network such as a local area network (LAN). The server 110 may also include one or more back-end servers for carrying out one or more aspects of the present disclosure. In some embodiments, the server 110 may be the same as or similar to server 400 described below in the context of FIG. 4. In addition, the server 110 may be implemented on Amazon Web Services (AWS) and may include a plurality of EC2 (Amazon Elastic Compute Cloud) instances or other types of virtual machines, with each instance also including various node processes.

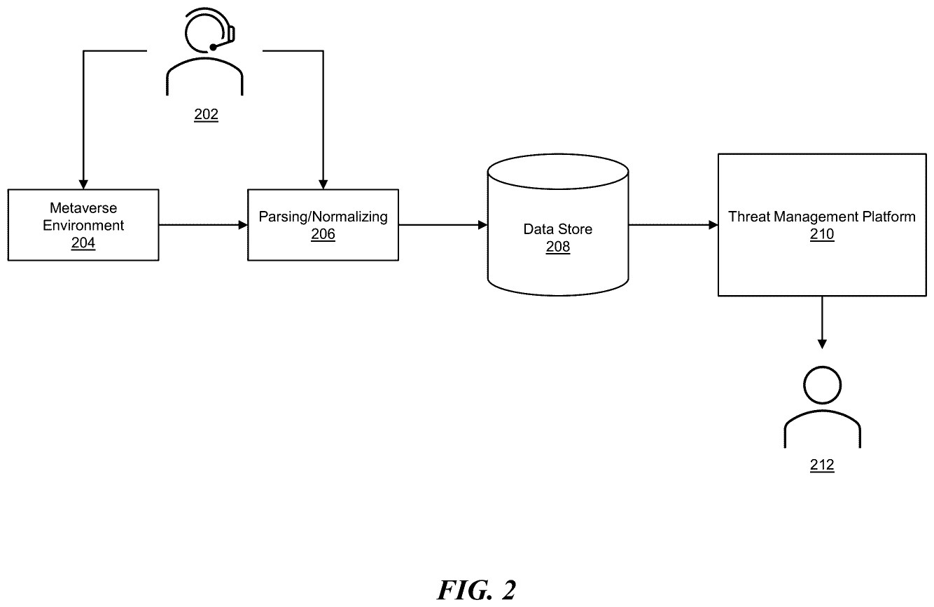

FIG. 2 is an example flowchart for metaverse monitoring that can be performed within the system of FIG. 1 according to some embodiments of the present disclosure. The entity 202 can be a threat collections entity 202 that includes a system of servers and other computing devices, such as the server 110 and the analyst device 112 from FIG. 1. The threat collections entity can be responsible for accessing a metaverse environment 204 (e.g., virtual environment 104), such as to control and manage a virtual monitor (e.g., virtual monitor 106), bot, avatar, and the like to collect content to be analyzed. The threat collections entity 202 is also able to access a parsing/normalization stage 206, such as to configure the parsing and normalizing algorithms or to obtain parsed/normalized content for analysis. Content collected from the metaverse environment is parsed and/or normalized at 206, which is then transmitted for maintenance and storage in a data store 208. In some embodiments, the data store 208 can be similar to or the same as the data store 122 of FIG. 1. Once the processed content is available in the data store 208, an end user 212 can access it via the threat management platform 210. In some embodiments, accessing the processed content can be done via a search (e.g., a unified cyberthreat search) or via alerting procedures. In alerting procedures, the threat management platform 210 is configured to monitor for potentially harmful content associated with the end user 212 and provide alerts when such content is detected. In this manner, an end user 212 can be notified of harmful or malicious content that originates from a metaverse environment 204.

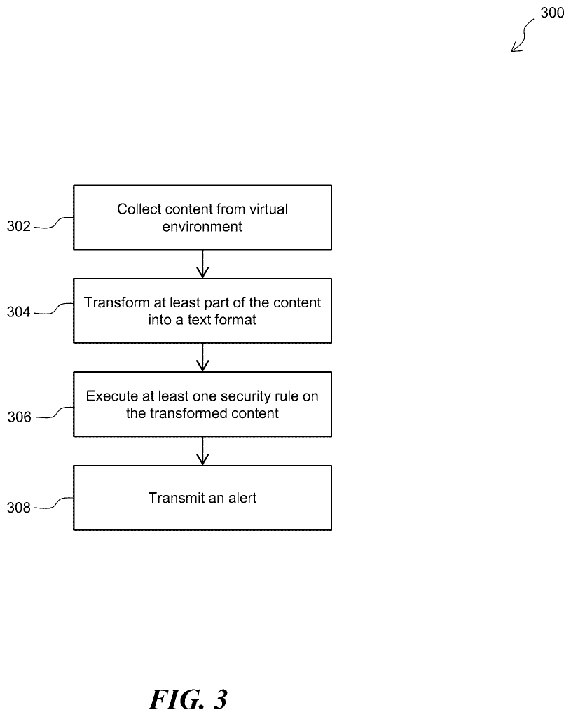

FIG. 3 is an example process 300 for generating threat alerts from a metaverse environment that can be performed within the system of FIG. 1 according to some embodiments of the present disclosure. In some embodiments, at least a portion of process 300 is performed by the server 110 and its various modules. At block 302, the server 110 collects content from a virtual environment, such as virtual environment 104. In some embodiments, the content can be audio and/or video content and can be collected by a virtual monitor 106, such as a controlled bot or avatar operating within the virtual environment 104 under control of the server 110. For example, the virtual monitor 106 can record audio and video and transmit the recordings to the server 110. In some embodiments, the server 110 can stream the content via the virtual monitor 106. In some embodiments, the virtual monitor 106 can collect content based on a set of rules, such as rules defined by an analyst via analyst device 112. In some embodiments, the virtual monitor 106 can navigate the virtual environment 104 and collect content, which is then streamed back to the server 110 for analysis. Rules would generally be contained within the server 110 for analysis, although this is not necessarily required. In some embodiments, the rules can control the virtual monitor 106 by informing it how to navigate. The rules can also control other configurable aspects of raw collection.

At block 304, the text translating module 114 transforms at least part of the collected content into a textual format. This can include utilizing various speech-to-text algorithms that transform the audio content (or audio content from a video sample) into textual strings. In some embodiments, transforming content into a text format can also include normalizing the text via the text normalization module 116. As discussed above, text normalization can generally include various techniques for reducing variety and randomness within textual strings, such as stemming and lemmatization, which reduce inflectional forms and derivationally related forms of a word to a common base form.

At block 306, the rule engine 120 executes at least one security rule on the transformed content. In other words, the rule engine 120 performs rule-based detection of threats and violations on the content. The rule engine 120 can execute rules against the transformed textual content. In the embodiments in which the textual content is normalized, the rule engine 120 can execute the security rules on the normalized textual content. Executing security rules can be used to identify threats, which can include various desired incidents, such as threats of violence or attack, profanity, hatefulness, weapons, phishing, malware, and various other types of content that may be indicative of harm coming to an entity. At block 308, the server 110 transmits an alert to a user device, such as the client endpoint 124 of FIG. 1. In some embodiments, the alert can be delivered via the threat platform 126 or another medium, such as a text message or email.

FIG. 4 is a diagram of an example server device 400 that can be used within system 100 of FIG. 1. Server device 400 can implement various features and processes as described herein. Server device 400 can be implemented on any electronic device that runs software applications derived from complied instructions, including without limitation personal computers, servers, smart phones, media players, electronic tablets, game consoles, email devices, etc. In some implementations, server device 400 can include one or more processors 402, volatile memory 404, non-volatile memory 406, and one or more peripherals 408. These components can be interconnected by one or more computer buses 410.

Processor(s) 402 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 410 can be any known internal or external bus technology, including but not limited to ISA, EISA, PCI, PCI Express, USB, Serial ATA, or Fire Wire. Volatile memory 404 can include, for example, SDRAM. Processor 402 can receive instructions and data from a read-only memory or a random access memory or both. Essential elements of a computer can include a processor for executing instructions and one or more memories for storing instructions and data.

Non-volatile memory 406 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 406 can store various computer instructions including operating system instructions 412, communication instructions 414, application instructions 416, and application data 417. Operating system instructions 412 can include instructions for implementing an operating system (e.g., Mac OS®, Windows®, or Linux). The operating system can be multi-user, multiprocessing, multitasking, multithreading, real-time, and the like. Communication instructions 414 can include network communications instructions, for example, software for implementing communication protocols, such as TCP/IP, HTTP, Ethernet, telephony, etc. Application instructions 416 can include instructions for various applications. Application data 417 can include data corresponding to the applications.

Peripherals 408 can be included within server device 400 or operatively coupled to communicate with server device 400. Peripherals 408 can include, for example, network subsystem 418, input controller 420, and disk controller 422. Network subsystem 418 can include, for example, an Ethernet of WiFi adapter. Input controller 420 can be any known input device technology, including but not limited to a keyboard (including a virtual keyboard), mouse, track ball, and touch-sensitive pad or display. Disk controller 422 can include one or more mass storage devices for storing data files; such devices include magnetic disks, such as internal hard disks and removable disks; magneto-optical disks; and optical disks.

FIG. 5 is an example computing device that can be used within the system 100 of FIG. 1, according to an embodiment of the present disclosure. In some embodiments, device 500 can be one or more of the client endpoint 124 and the analyst device 112. The illustrative user device 500 can include a memory interface 502, one or more data processors, image processors, central processing units 504, and/or secure processing units 505, and peripherals subsystem 506. Memory interface 502, one or more central processing units 504 and/or secure processing units 505, and/or peripherals subsystem 506 can be separate components or can be integrated in one or more integrated circuits. The various components in user device 500 can be coupled by one or more communication buses or signal lines.

Sensors, devices, and subsystems can be coupled to peripherals subsystem 506 to facilitate multiple functionalities. For example, motion sensor 510, light sensor 512, and proximity sensor 514 can be coupled to peripherals subsystem 506 to facilitate orientation, lighting, and proximity functions. Other sensors 516 can also be connected to peripherals subsystem 506, such as a global navigation satellite system (GNSS) (e.g., GPS receiver), a temperature sensor, a biometric sensor, magnetometer, or other sensing device, to facilitate related functionalities.

Camera subsystem 520 and optical sensor 522, e.g., a charged coupled device (CCD) or a complementary metal-oxide semiconductor (CMOS) optical sensor, can be utilized to facilitate camera functions, such as recording photographs and video clips. Camera subsystem 520 and optical sensor 522 can be used to collect images of a user to be used during authentication of a user, e.g., by performing facial recognition analysis.

Communication functions can be facilitated through one or more wired and/or wireless communication subsystems 524, which can include radio frequency receivers and transmitters and/or optical (e.g., infrared) receivers and transmitters. For example, the Bluetooth (e.g., Bluetooth low energy (BTLE)) and/or WiFi communications described herein can be handled by wireless communication subsystems 524. The specific design and implementation of communication subsystems 524 can depend on the communication network(s) over which the user device 500 is intended to operate. For example, user device 500 can include communication subsystems 524 designed to operate over a GSM network, a GPRS network, an EDGE network, a WiFi or WiMax network, and a Bluetooth™ network. For example, wireless communication subsystems 524 can include hosting protocols such that device 500 can be configured as a base station for other wireless devices and/or to provide a WiFi service.

Audio subsystem 526 can be coupled to speaker 528 and microphone 530 to facilitate voice-enabled functions, such as speaker recognition, voice replication, digital recording, and telephony functions. Audio subsystem 526 can be configured to facilitate processing voice commands, voice-printing, and voice authentication, for example.

I/O subsystem 540 can include a touch-surface controller 542 and/or other input controller(s) 544. Touch-surface controller 542 can be coupled to a touch-surface 546. Touch-surface 546 and touch-surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 546.

The other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of speaker 528 and/or microphone 530.

In some implementations, a pressing of the button for a first duration can disengage a lock of touch-surface 546; and a pressing of the button for a second duration that is longer than the first duration can turn power to user device 500 on or off. Pressing the button for a third duration can activate a voice control, or voice command, module that enables the user to speak commands into microphone 530 to cause the device to execute the spoken command. The user can customize a functionality of one or more of the buttons. Touch-surface 546 can, for example, also be used to implement virtual or soft buttons and/or a keyboard.

In some implementations, user device 500 can present recorded audio and/or video files, such as MP3, AAC, and MPEG files. In some implementations, user device 500 can include the functionality of an MP3 player, such as an iPod™. User device 500 can, therefore, include a 36-pin connector and/or 8-pin connector that is compatible with the iPod. Other input/output and control devices can also be used.

Memory interface 502 can be coupled to memory 550. Memory 550 can include high- speed random access memory and/or non-volatile memory, such as one or more magnetic disk storage devices, one or more optical storage devices, and/or flash memory (e.g., NAND, NOR). Memory 550 can store an operating system 552, such as Darwin, RTXC, LINUX, UNIX, OS X, Windows, or an embedded operating system such as VxWorks.

Operating system 552 can include instructions for handling basic system services and for performing hardware dependent tasks. In some implementations, operating system 552 can be a kernel (e.g., UNIX kernel). In some implementations, operating system 552 can include instructions for performing voice authentication.

Memory 550 can also store communication instructions 554 to facilitate communicating with one or more additional devices, one or more computers and/or one or more servers. Memory 550 can include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic messaging-related process and functions; web browsing instructions 564 to facilitate web browsing-related processes and functions; media processing instructions 566 to facilitate media processing-related functions and processes; GNSS/Navigation instructions 568 to facilitate GNSS and navigation-related processes and instructions; and/or camera instructions 570 to facilitate camera-related processes and functions.

Memory 550 can store application (or “app”) instructions and data 572, such as instructions for the apps described above in the context of FIGS. 1-3 and for modules 114-120 and others. Memory 550 can also store other software instructions 574 for various other software applications in place on device 500.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A system for monitoring a virtual reality environment for cyberthreats comprising:
a server comprising one or more processors and a memory storing instructions that, when executed, cause the one or more processors to perform a process operable to:
collect content from a virtual reality environment;
transform at least part of the collected content into a textual format;
execute at least one security rule on the transformed content to detect threatening content; and
in response to detecting the threatening content, transmit an alert to a user device.

2. The system of claim 1, wherein collecting the content from the virtual reality environment comprises ingesting content via a server-controlled avatar or bot operating within the virtual reality environment.

3. The system of claim 2, wherein ingesting the content via the server-controlled avatar or bot comprises recording audio within the virtual reality environment.

4. The system of claim 2, wherein ingesting the content via the server-controlled avatar or bot comprises recording video within the virtual reality environment.

5. The system of claim 2, wherein the process is operable to stream the collected content via the server-controlled avatar or bot.

6. The system of claim 2, wherein the process is operable to navigate the server-controlled avatar or bot within the virtual reality environment.

7. The system of claim 1, wherein transforming the at least part of the collected content into a textual format comprises applying one or more speech-to-text algorithms to the collected content.

8. The system of claim 1, wherein the process is operable to, prior to executing the at least one security rule, perform a text-normalization procedures on the transformed content.

9. A computer-implemented method, performed by one or more processors, for monitoring a virtual reality environment for cyberthreats comprising:
collecting content from a virtual reality environment;
transforming at least part of the collected content into a textual format;
executing at least one security rule on the transformed content to detect threatening content; and
in response to detecting the threatening content, transmitting an alert to a user device.

10. The computer-implemented method of claim 9, wherein collecting the content from the virtual reality environment comprises ingesting content via a server-controlled avatar or bot operating within the virtual reality environment.

11. The computer-implemented method of claim 10, wherein ingesting the content via the server-controlled avatar or bot comprises recording audio within the virtual reality environment.

12. The computer-implemented method of claim 10, wherein ingesting the content via the server-controlled avatar or bot comprises recording video within the virtual reality environment.

13. The computer-implemented method of claim 10 comprising streaming the collected content via the server-controlled avatar or bot.

14. The computer-implemented method of claim 10 comprising navigating the server-controlled avatar or bot within the virtual reality environment.

15. The computer-implemented method of claim 9, wherein transforming the at least part of the collected content into a textual format comprises applying one or more speech-to-text algorithms to the collected content.

16. The computer-implemented method of claim 9 comprising, prior to executing the at least one security rule, perform a text-normalization procedures on the transformed content.
